(19) United States
(12) Patent Application Publication
(10) Pub. No.: US 2017/0089120 A1
(43) Pub. Date: Mar. 30, 2017

(54) THERMALLY INSULATING SPACER PROFILE

(71) Applicant: ENSINGER GMBH, Nufringen (DE)

(72) Inventors: Michael Möller, Cham (DE); Sven Rohde, Ehningen (DE)

(21) Appl. No.: 15/372,994

(22) Filed: Dec. 8, 2016

Related U.S. Application Data
(63) Continuation of application No. PCT/EP2015/063096, filed on Jun. 11, 2015.

(30) Foreign Application Priority Data
Jun. 12, 2014 (DE) 10 2014 108 264.8

(51) Int. Cl. E06B 3/263; E04B 2/96; E06B 3/64

(52) U.S. Cl. CPC E06B 3/263; E06B 3/64; E04B 2/96; E06B 2003/2635

(57) ABSTRACT

A spacer profile comprises:
a basic body extending in a longitudinal direction of the profile with an outer contour which is substantially rectangular or trapezoid-shaped in a cross-section perpendicular to the longitudinal direction;
the body comprising first and second transverse walls connected by a single side wall element and held at a pre-set spacing h;
the side wall element ending with a first end at a first edge region of the first transverse wall and with a second end at a first edge region of the second transverse wall;
the side wall element forming a path for thermal conduction from the first transverse wall to the second transverse wall, the path length approximately 1.1 or more times the spacing h;
and comprising an anchoring protrusion held on the first transverse wall and extends from the body in a direction opposite to the second transverse wall.

### CROSS REFERENCE TO RELATED APPLICATIONS

This patent application is a Continuation of International Patent Application No. PCT/EP2015/063096, filed Jun. 11, 2015, which claims the benefit of German Patent Application No. 10 2014 108 264.8, filed Jun. 12, 2014, which are each incorporated by reference.

### BACKGROUND OF THE INVENTION

The invention relates to a thermally insulating spacer profile made of a plastics material, in particular for facade or glass roof constructions and windows and door elements, comprising a basic body extending in a longitudinal direction of the spacer profile with a substantially rectangular outer contour, wherein the basic body comprises a first and second transverse wall which are connected to one another and are held at a pre-set spacing, and comprising a strip-like anchoring protrusion which is held on the first transverse wall and which extends from the basic body in a direction opposite to the second transverse wall.

Spacer profiles of this type are used, in particular, for holding at a spacing, for insulating purposes and for filling gaps between adjacent glass panes or other facade panels of facade and glass roof constructions. They are known in the form of hollow chamber profiles with one or more hollow chambers, for example, from DE 299 00 770 U1 or DE 200 21 878 U1. From DE 20 2012 004 710 U1 and EP 2 642 039 A1, there are known spacer profiles of this type made of foamed material.

### BRIEF SUMMARY OF THE INVENTION

It is an object of the invention to propose a spacer profile of the aforementioned type which enables improved thermal insulation.

This object is achieved by a spacer profile having the features of claim 1.

Due to the restriction of the geometry of the spacer profile according to the invention to just a single side wall element which holds the two transverse walls at a pre-set spacing h and thus has a supporting function, the wall cross-section which is available in the direction from the first to the second transverse wall for thermal conduction, can be substantially reduced.

This enables a better thermal insulation and also opens up a material selection from a broader palette of plastics materials. In particular, the plastics materials can be further optimized in many respects by means of additives and/or fillers for the application concerned.

Furthermore, by the stipulation that the course of the side wall element from the first to the second transverse wall has a length which is approximately 1.1 or more times the spacing h of the first transverse wall from the second, the path for the thermal conduction is extended, which results in a further optimization of the thermal insulation.

The substantially rectangular or trapezoid-shaped outer contour of the basic body includes both the cuboid shape and also the wedge shape. Thus the transverse walls can have a different extent in the transverse direction (width) of the outer contour and/or an arrangement differing from the mutually parallel arrangement.

In the context of a wedge-shaped form of the outer contour, the width of one transverse wall is preferably restricted to approximately three times the width of the other transverse wall.

The advantages of the invention lie, in particular, therein that
production can take place with a minimised use of plastics material,
mechanical properties comparable with conventional spacer profiles are enabled with a lower mass,
the economical use of a wider range of polymer materials is permitted in order thereby to enable additional economic, ecological and/or technical benefits.

Further preferably, the side wall element defines a path for the thermal conduction from the first transverse wall to the second transverse wall, the length of said path corresponding to approximately 1.2 ore more times the mutual spacing h of the transverse walls from one another.

The mechanical properties can be ensured to a sufficient degree by a suitable selection of plastics materials, the properties of which are also optimised with additives, if required. The material selection can also take place applying economic considerations.

The first and second transverse wall are often oriented substantially parallel to one another. If the first and second transverse walls are not oriented parallel to one another, the spacing h is understood to be the mean spacing of the transverse walls.

Seen in cross-section perpendicular to the longitudinal extent of the spacer profile, the side wall element comprises one or more portions.

This portion or plurality of portions of the side wall element can be configured flat, curved or angled.

In the simpler cases, the spacer profiles according to the invention can have an arrangement of the transverse walls and of the side wall element which resembles a Σ-form, an X-form or a Z-form.

In a preferred spacer profile, the side wall element comprises two or more portions which are arranged at different angles relative to the first and second transverse wall.

A further preferred spacer profile has a side wall element in which at least one such portion is provided which is arranged substantially perpendicularly to the first or second transverse wall.

According to a further preferred embodiment, the spacer profile according to the invention has a side wall element which comprises at least one portion which is arranged substantially parallel to the first and second transverse wall, wherein the portion preferably extends over the whole width of the basic body.

In one embodiment of the spacer profile according to the invention, the first edge region of the first transverse wall and the first edge region of the second transverse wall at which the side wall element respectively ends are arranged at opposite sides of the basic body.

In an alternative embodiment thereto of the spacer profile according to the invention, the first edge region of the first transverse wall and the first edge region of the second transverse wall at which the side wall element ends are arranged at the same side of the basic body.

Spacer profiles according to the invention which are used for the production of facades preferably comprise, in cross-section, on at least one of the first and second transverse walls and/or on at least one of the portions of the side wall element, a profiling which is configured as a screw guide. This facilitates the placement of the screws and their screw connection with further facade elements, since a guide is provided for the screws in the longitudinal direction.

Preferably, a spacer profile according to the invention has in cross-section, two or more profilings configured as screw guides, wherein the profilings are oriented to one another such that they are arranged in one plane, preferably a plane of symmetry, of the basic body.

The profilings, which serve as screw guides can be configured highly varied, in particular, the profiling comprises a recess, a protrusion and/or a through opening at a transverse wall or at a portion of the side wall element.

In one variant of the spacer profile according to the invention, the second transverse wall comprises a protrusion on its side facing away from the first transverse wall on the first edge region and on the second edge region opposite the first edge region. These protrusions can be provided with latching elements so that cover strips covering the spacer profiles can be mounted with a latching connection.

The spacer profiles according to the invention, due to the restriction to a single side wall element, can easily be equipped on one or more of the portions of the side wall element and/or on at least one of the transverse walls on a surface oriented toward the anchoring protrusion and/or away from the anchoring protrusion with a layer reflecting infrared radiation. Thus, a further improvement of the thermal insulation can be achieved which, with the hollow chamber profiles closed is not possible with simple measures.

As an alternative to the equipping of the spacer profiles according to the invention with infrared-reflecting foils, or possibly in addition thereto, it can be provided according to the invention that at least a partial volume of the basic body is filled with a foam material. The foam material can be held by a substance-to-substance bond, and/or in positive- and/or force-locking manner in the partial volumes and, if needed, the spacer profile can be configured with mechanical strengthening.

For further optimisation of properties of the spacer profile according to the invention, it can be provided that the basic body is covered on its outer sides extending between the transverse walls partially or substantially completely with a foil extending from the first transverse wall to the second transverse wall or with a foamed surface material.

These foils or foamed surface materials do not make any appreciable contribution to the stabilisation of the profile geometry of the spacer profile against compressive forces and the thermal conduction properties of the spacer profile remain substantially unchanged. However, a simplification of the handling during mounting can thereby be achieved.

In the cases in which the spacer profile according to the invention in the installed situation is arranged at a larger lateral spacing from the further facade elements, the foil or the foamed surface material also significantly improves the thermal insulation, since it reduces the volumes of the then existing hollow spaces and so significantly reduces the heat transmission through convection.

Additionally or alternatively to the foils or foamed surface materials, spacer profiles according to the invention can be equipped at least at one of the transverse walls and/or at one of the portions of the side wall element on a region adjoining the outer contour of the basic body with a sealing element, for example in the form of sealing bands or sealing lips. The sealing element can be configured, in particular, in the form of a protrusion which projects laterally from the basic body which, in particular, can also be produced integrally with the side wall element, the foil or the foamed surface material.

Under a further aspect of the handling of the spacer profiles according to the invention, it can be provided that, at one or more of the portions of the side wall element and/or at the first and/or second transverse wall, support elements are provided which, on loading of the spacer profile in the direction from the second transverse wall to the first transverse wall and vice versa, are bringable into abutment with a further portion of the side wall element and/or with the first and/or second transverse wall. The support elements can also be configured so that, in each case, two support elements are configured oriented toward one another and, in the case of a loading of the spacer profile, come into contact with one another with their free ends and are supported against one another. In the final mounted state, the free ends are again spaced from one another.

The spacer profiles according to the invention are equipped, as mentioned in the introduction, with a strip-like anchoring protrusion, which extends from the first transverse wall. The geometry of the strip-like anchoring protrusions can be highly varied. In particular, the anchoring protrusions can comprise latching elements by means of which the spacer profiles can firstly be latched at the mounting location before they are subsequently fixed by means of screws. The strip-like anchoring protrusions can also have a trapezoid cross-section.

According to a first alternative, the anchoring protrusion can comprise two substantially parallel wall portions which are preferably connected to one another by means of a transverse web. Here, the anchoring protrusion additionally takes on the function of a screw guide.

According to a further alternative, in a spacer profile according to the invention, the anchoring protrusion is formed closed at its free end.

Furthermore, in a spacer profile according to the invention, the anchoring protrusion can be formed open at its free end.

The transverse web of the anchoring protrusion is preferably provided at approximately one third to approximately two thirds of the height of the anchoring protrusion and preferably comprises a profiling configured as a screw guide.

Spacers according to the invention which are to be used as insulating profile webs in composite profiles generally have, apart from the first strip-like anchoring protrusion, a second anchoring protrusion, wherein both protrusions are configured, in particular massively, for example trapezoid-shaped, adapted to dovetail guides of metal profiles and thus provide the rolling-in capability.

The spacer profiles according to the invention can be produced from a plastics material which, as mentioned above, can be selected from a broad spectrum.

Suitable plastics materials are, in particular, polyamides, polyesters, polyethers, polyolefins, polyaryletherketones, polyacetals, polycarbonates, polyacrylates, polystyrenes, polyphenylene ethers, polyurethanes, epoxy resins, polysulphones, vinylpolymers, polyphenylene sulphides, copolymers and/or blends of these plastics materials.

The above-mentioned plastics materials can be used as thermoplastics or, as is known for various of these materials, in cross-linked form as thermosetting plastics.

Furthermore, the plastics materials of porous form, for example with a pore volume content of approximately 1% to 20% by volume can be used.

Particularly preferred plastics materials are polyamides, in particular PA66, PA6 and PPA (polyphthalamide), polyesters, in particular PET (polyethylene terephthalate) and PBT (polybutylene terephthalate), polyolefins, in particular polypropylene (PP) and polypropylene copolymers, polyphenylene sulphides, polyphenylene ethers (PPE), polystyrene (PS), polyvinyl chloride (PVC) and acrylonitrile butadiene styrene (ABS) copolymers.

The aforementioned plastics materials are preferably used in a fibre-reinforced form.

Additionally, as mentioned in the introduction, the plastics materials can be modified for the respective case of use and optimised in their properties by means of additives and/or fillers.

Particularly preferred additives and fillers are

inorganic fibres, in particular glass fibres, carbon fibres, mineral fibres and carbon nanotubes, which are used for strengthening purposes; the glass fibres can also be utilised, in particular, in the form of short glass fibres or long glass fibres, endless fibres and in the form of so-called rovings;

organic fibres, in particular polymer fibres (polyamide fibres, aramide fibres, polyester fibres) and natural fibres (cellulose, sisal, flax, kenaf fibres), which are also used for strengthening purposes;

siliceous fillers, in particular wollastonite, feldspar, silicic acid, sand, sheet silicates (talcum, mica, montmorillonite, vermiculite, hecorite, saponite), which also have a strengthening effect;

fillers based on glass, in particular E-glass, S-glass (in the form of, for example, ground glass, spheres, hollow spheres, foamed glass), with which firstly the density of the plastics material can be reduced, secondly a cost-optimisation of the plastics material is possible;

carbonates, in particular lime and chalk, which can be used to optimise the cost of the plastics material;

oxides, in particular so-called LDHs (layered double hydroxides), for example, aluminium oxides/hydroxides, magnesium oxides/hydroxides, which serve to improve the fire protection;

fire protection additives and compositions, in particular those named in the handbook by Zweifel, Maier, Schiller: “Plastic Additives Handbook”, 6th Edition, Hanser Verlag, chapter 12: Flame retardants, pages 705 to 709; and

sulphates, in particular gypsum, which are also suitable for cost optimisation of the plastics materials.

The proportions of the additives and fillers in the plastics material can vary within wide ranges to take account of the respective uses and the requirements they place on the spacer profile. They amount to a total of approximately 0.1% to approximately 50% by weight, in particular approximately 10% to approximately 40% by weight.

For example, glass fibre-reinforced plastics materials based on polypropylene or polyamide preferably contain approximately 10% to approximately 40% by weight of glass fibres. From these materials, spacer profiles according to the invention can be produced by extrusion.

For pultruded profiles, endless glass fibres can also be used, wherein the proportion of the reinforced plastics material can amount, for example, to approximately 50% by weight or more, particularly in the case of epoxy-based spacer profiles.

Spacer profiles according to the invention which are used, for example, in the production of thermally insulating composite profiles for the manufacturing of window frames, door frames and facade elements as insulating profile webs and which connect an externally located metal profile to an internally located metal profile have an anchoring protrusion at both the first and the second transverse wall. These anchoring protrusions are often formed with a trapezoid-shaped cross-section and can be used in correspondingly formed dovetail guides of the metal profiles and fixed by means of a so-called rolled-in joint.

Conventional spacer profiles of this type with the function of an insulating profile web are known in many forms in the prior art, for example from DE 198 04 322 C2. Recently, a composite profile of this type has been disclosed in DE 10 2013 010 336 A1.

### BRIEF DESCRIPTION OF THE SEVERAL VIEWS OF THE DRAWINGS

This and other embodiments and advantages of the invention will now be described in greater detail based on the drawings, in which:

FIGS. 1A and 1B show schematic representations of a first and a second embodiment of a spacer profile according to the invention;

FIGS. 2A, 2B, and 2C show schematic representations of a third, fourth and fifth embodiment of a spacer profile according to the invention;

FIGS. 3A, 3B, 3C, 3D, 3E, 3F, and 3G show schematic representations of further embodiments of the spacer profile according to the invention;

FIGS. 4A, 4B, 4C, and 4D show four variants of a spacer profile according to the invention with a side wall element in a meandering form;

FIG. 5 shows a spacer profile according to the invention with foam-filled partial volumes;

FIGS. 6A and 6B show spacer profiles according to the invention in an installed situation;

FIGS. 7A and 7B show two embodiments of the spacer profile according to the invention in the form of insulating profile webs; and

FIGS. 8A and 8B show two embodiments of the spacer profile according to the invention with a trapezoid-shaped outer contour.

### DETAILED DESCRIPTION OF THE INVENTION

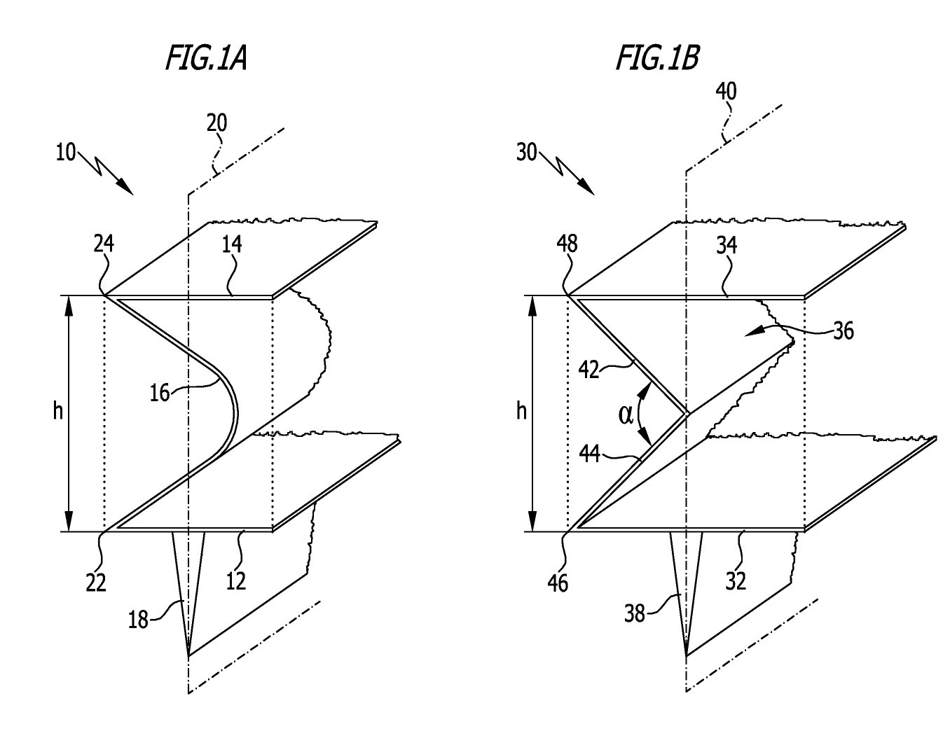

FIG. 1A shows a spacer profile 10 according to the invention with a first transverse wall 12, a second transverse wall 14 and a side wall element 16 connecting and supporting the first transverse wall to the second. The side wall element 16 is herein formed curved and defines a path for the thermal conduction from the first transverse wall 12 to the second transverse wall 14 which is significantly longer than the height of the spacing h between the first transverse wall 12 and the second transverse wall 14.

Typically, the transverse walls 12 and 14 are arranged parallel to one another. Thus a basic body results which is substantially rectangular in cross-section (shown dotted).

The side wall element 16 is attached at a first edge region 22 of the first transverse wall 12 and ends at a first edge region 24 of the second transverse wall 14. The edge regions 22 and 24 of the first and second transverse wall are arranged in this exemplary embodiment on the same side of the basic body.

The first transverse wall 12 has, at its side facing away from the transverse wall 14, a strip-like anchoring protrusion 18 which is arranged approximately centrally in the transverse direction of the spacer profile 10, i.e. in the region of a central plane 20 of the basic body.

Due to the curved surface of the side wall element 16, it reaches with its summit to somewhat beyond the central plane 20 of the basic body of rectangular-shape in cross-section defined by the two transverse walls 12 and 14 and crosses this central plane. The path length for the thermal conduction in the side wall element 16 is approximately 1.45 times the spacing h of the first transverse wall 12 from the second transverse wall 14.

FIG. 1B shows a similarly constructed spacer profile 30 with a first transverse wall 32, a second transverse wall 34 arranged parallel thereto and a side wall element 36 which connects the two transverse walls 32 and 34 to one another and holds them at a pre-set spacing h. At the side facing away from the second transverse wall 34, the first transverse wall 32 has a strip-like anchoring protrusion 38 which is also arranged in the region of a central plane 40 of the basic body of the spacer profile 30.

The supporting side wall element 36 is formed of two portions 42, 44 which are arranged at an angle α of approximately 90° to one another. The path length thus defined for the thermal conduction is approximately 1.4 times the height h. The angle α can be varied within a wide range, in particular from approximately 30° to approximately 130°, preferably approximately 45° to approximately 110°.

The side wall element 36 connects at a first edge region 46 of the first transverse wall 32 and ends at a first edge region 48 of the second transverse wall 34. The edge regions 46 and 48 of the first and second transverse wall 32, 34 are arranged, in this example, on the same side of the basic body.

Again, there results a path for the thermal conduction over the length of the side wall element 36 from the first transverse wall 32 to the second transverse wall 34 which is significantly longer than the height of the spacing h between the first transverse wall 32 and the second transverse wall 34.

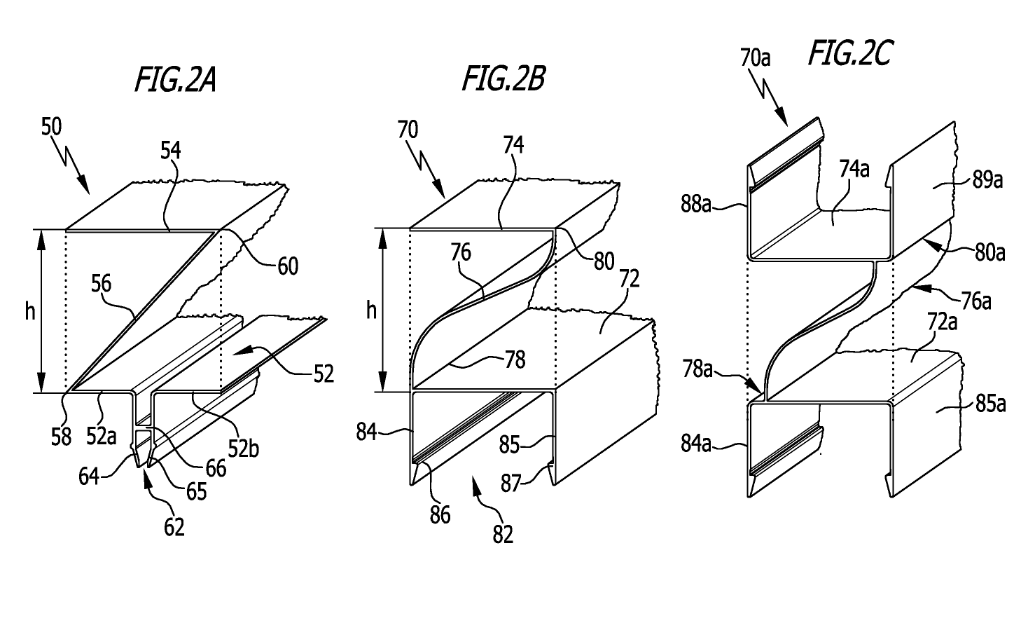

FIGS. 2A to 2C show embodiments of the spacer profile according to the invention which have a Z-shape.

In FIG. 2A, a spacer profile 50 comprises a first transverse wall 52, a second transverse wall 54 arranged parallel thereto and a side wall element 56 supporting and connecting the first transverse wall 52 to the second transverse wall 54.

As distinct from the embodiments of FIGS. 1A and 1B, the side wall element 56 is arranged on a first edge region 58 of the first transverse wall 52 and on a first edge region 60 of the second transverse wall 54 on the opposite side of the basic body. The path length for the thermal conduction in the side wall element 56 is more than 1.35 times the spacing h of the first from the second transverse wall 52, 54.

The spacer profile 50 of FIG. 2A has a first transverse wall 52 which is subdivided into two strip-like portions 52a, 52b which extend parallel to the longitudinal direction of the profile 50.

The transverse wall 52 also has formed thereon a strip-like anchoring protrusion 62 which is formed of two substantially parallel wall portions 64, 65 and a transverse web 66 connecting these two wall portions to one another.

In this way, the gap between the two strip-like portions 52a and 52b of the first transverse wall 52 is also bridged and closed.

The anchoring protrusion 62 has at its free ends a somewhat narrowed geometry, whereby a spacing of the wall portions 64, 65 from one another is maintained even at the free end.

A further Z-shaped embodiment of a spacer profile according to the invention is shown in FIG. 2B.

The spacer profile 70, with a first transverse wall 72, a second transverse wall 74 and a side wall element 76 arranged holding (carrying) these two transverse walls at a defined spacing and connectingly, again defines a basic body with a rectangular cross-sectional geometry.

The side wall element 76 is formed onto the first transverse wall 72 at a first edge region 78, whilst the side wall element 76 is connected to the second transverse wall 74 with it first edge region 80, which is arranged, in the geometry of the rectangular-shaped basic body, diagonally opposite to the first edge region 78.

The side wall element 76 defines a path for the thermal conduction which is approximately 1.45 times the height h, i.e. the spacing of the first and second transverse wall 72, 74.

On the side of the first transverse wall 72 facing away from the second transverse wall 74, the first transverse wall carries a strip-like anchoring protrusion 82 with two wall portions 84, 85 which are formed substantially flat and have latching elements 86, 87 on their free ends. The anchoring protrusion 82 is again arranged symmetrically about the central plane of the basic body.

FIG. 2C shows a modification of the embodiment of FIG. 2B wherein a spacer profile 70a comprises a first transverse wall 72a, a second transverse wall 74a arranged parallel thereto and therebetween a side wall element 76a holding these two transverse walls 72a, 74a at a spacing.

The side wall element 76a is formed onto an edge region 78a of the first transverse wall 72a, wherein as distinct from the embodiment of FIG. 2B, the connection of the side wall element 76a to the first transverse wall 72a does not take place exactly at the outermost edge of the transverse wall 72a, but at a slight spacing therefrom.

Similarly, the side wall element 76a is formed onto the second transverse wall 74a at a certain spacing from the edge of this transverse wall in the first edge region 80a.

Formed onto the first transverse wall 72a, facing downwardly, i.e. away from the second transverse wall 74a are strip-like anchoring protrusions 84a, 85a which have substantially the same geometry as the anchoring protrusions 84 and 85 of FIG. 2B.

Furthermore, the spacer profile 70a as shown in FIG. 2C comprises, at the second transverse wall 74a, facing away from the first transverse wall 72a, anchoring protrusions 88a, 89a which are configured substantially identically to the anchoring protrusions 84a, 85a.

The anchoring protrusions 84a, 85a and 88a, 89a are each formed directly onto the outermost edge respectively of the first and second transverse wall 72a, 74a. However, it is also conceivable to form these anchoring protrusions on at a certain spacing from the respective outer edge of the transverse walls 72a and 74a.

Whilst the anchoring protrusions 84a, 85a are configured as latching connectors with which the spacer profile can be connected to a facade-side substructure, the anchoring protrusions 88a, 89a which are also configured as latching connectors serve for the connection of the spacer profile 70a to a so-called press-on strip (not shown).

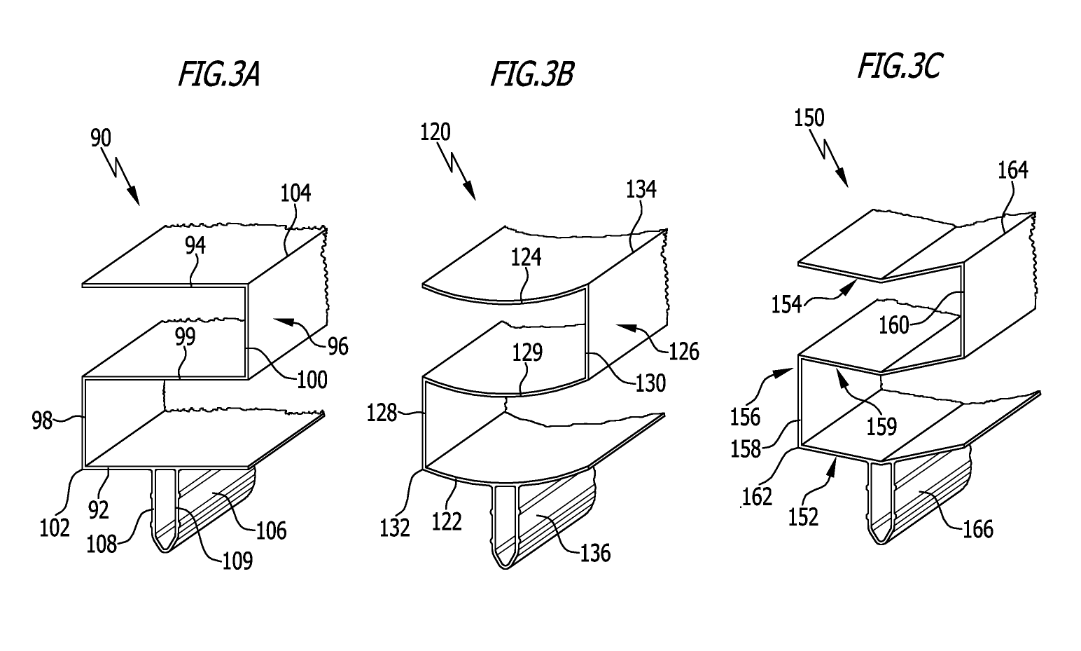

FIGS. 3A to 3C show a first embodiment of a construction of the spacer profile also referred to below as a meandering structure.

The spacer profile 90 of FIG. 3A has a first transverse wall 92, a second transverse wall 94 arranged parallel thereto and a side wall element 96 arranged connecting and holding the two transverse walls 92, 94 at a spacing.

The side wall element 96 is subdivided into three portions 98, 99, 100 which are each arranged at a right angle to one another. The first portion 98 of the side wall element 96 is attached to a first edge region 102 of the first transverse wall 92 and extends in the vertical direction from the transverse wall 92 in the direction toward the second transverse wall 94. Attached at the first portion 98 of the side wall element 96 is a portion 99 of the side wall element 96 arranged parallel to the first and second transverse wall 92, 94, said side wall element having substantially the same width as the transverse walls 92 and 94.

The first portion 98 is arranged parallel to the further portion 100. Formed on between these portions 98, 100 is the portion 99, again oriented vertically. The third portion 100 is attached to the first edge region 104 of the second transverse wall 94. Here also, a rectangular geometry again results in the arrangement of the portion 100 to the second transverse wall 94.

Held on the side of the first transverse wall 92 facing away from the second transverse wall 94, is a strip-like anchoring protrusion 106, which is constructed from two parallel wall portions 108, 109 which are mutually connected at their free bent-over ends and so form a closed hollow space with the transverse wall 92.

FIG. 3B shows a spacer profile 120 with a similar construction to the spacer profile 90.

A first transverse wall 122 is connected to and held at a spacing from a second transverse wall 124 by means of a side wall element 126. The two transverse walls 122, 124 are arranged substantially parallel to one another, but in contrast to the exemplary embodiment of FIG. 3A, not flat, but formed slightly curved.

The side wall element 126 has three portions 128, 129, 130 which are arranged respectively approximately at right angles to one another, wherein the first portion 128 is attached to an edge region 132 of the first transverse wall 122 and the third portion 130 ends at a first edge region 134 of the second transverse wall 124. The two first edge regions 132, 134 of the first and second transverse wall 122, 124 lie diagonally opposite at corners of the rectangular basic body.

The central or second portion 129 is arranged parallel to the transverse walls 122, 124 and has substantially the same width as these transverse walls.

At the side opposite the second transverse wall 124, the first transverse wall 122 has a strip-like anchoring protrusion 136 which here is only shown schematically as previously in FIGS. 1A and 1B.

The slight curvature of the second portion 129 of the side wall element causes, firstly, a lengthening of the path for the thermal conduction of the first and second transverse wall 122, 124. Secondly, on mounting of the spacer profile by means of screws (screwing-in direction extends from the second transverse wall to the anchoring protrusion) said curvature facilitates their orientation substantially along the central plane of the spacer profile when screwing them in. The same applies for the slight curvature of the first and second transverse wall 122, 124.

FIG. 3C shows a further variant of this basic type in the form of a spacer profile 150, wherein a first transverse wall 152 is held parallel to and at a spacing from a second transverse wall 154 by means of a side wall element 156.

The side wall element 156 has three portions 158, 159, 160 of which the first and third portion 158, 160 are formed flat, parallel to one another and substantially perpendicular to the orientation of the transverse walls 152, 154.

The first portion 158 of the side wall element 156 is attached to a first edge region 162 of the first transverse wall 152, whilst the third portion 160 of the side wall element 156 is attached to a first edge region 164 of the second transverse wall 154. The transverse walls 152, 154 and the second portion 159 of the side wall element 156 have not a flat, but rather a slightly angled configuration, wherein this geometry is oriented symmetrically about the central plane of the basic body of the spacer profile. The angled configuration of the second portion 159 again causes a lengthening of the path for the thermal conduction. The angled configuration of the first and second transverse wall 152, 154 and of the second portion 159 again facilitate a guidance of the screws on screwing in along the central plane of the basic body of the spacer profile 150.

Provided on the side of the first transverse wall 152 lying opposite the second transverse wall 154 is a strip-like anchoring protrusion 166 which is also arranged aligned to the central plane of the basic body.

FIG. 3D shows a spacer profile 170 according to the invention in a (mirror-image) Z-shape in cross-section with a first transverse wall 172, a second transverse wall 174 and a side wall element 176 connecting and supporting these two transverse walls relative to one another.

The side wall element 176 is attached to, preferably formed on, a first edge region 178 of the first transverse wall 172 and is connected, preferably integrally, at the opposite end to the first edge region 180 of the second transverse wall 174.

The side wall element 176 is subdivided into three portions 182, 183, 184 of which the first and the third portion are arranged parallel to one another, perpendicular to and respectively attached to the first edge region 178 or 180 of the first or second transverse wall 172, 174.

The second portion 183 lying therebetween extends substantially diagonally through the basic body of the spacer profile 170 and carries approximately centrally, projecting in the direction of the second transverse wall 174, a flange 186 which together with a segment of the central portion 183 of the side wall element 176, the third portion 184 of the side wall element 176 and the second transverse wall 174, forms a laterally open receptacle chamber 188 for a strand of insulating material, for example, in the form of a run of foam 190.

The first transverse wall 172 has a strip-like anchoring protrusion 192 extending away from the second transverse wall 174 which is arranged symmetrically about the central plane of the basic body of the spacer profile 170.

Two protrusions 194, 195 which can be conceived as latching connectors for a press-on profile (not shown) extend from the second transverse wall 174, facing away from the first transverse wall 172.

FIG. 3E shows a further spacer profile 200 according to the invention in Σ-form with a first transverse wall 202, a second transverse wall 204 and a side wall element 206 connecting and supporting the first and second transverse walls.

The side wall element 206 has four portions of which a first portion 208 is formed on a first edge region 207 of the first transverse wall 202 and extends perpendicularly from the first transverse wall in the direction toward the second transverse wall 204. Attached to the first portion 208 are second and third portions 209, 210 extending diagonally to the basic body of the spacer profile 200, which form an angle to one another of approximately 60°. Finally, a fourth portion 211 connects the third portion 210 to a first edge region 212 of the second transverse wall 204, which is arranged on the same side of the basic body of the spacer profile 200 as the first edge region 207 of the first transverse wall 202. The fourth portion 211 is oriented coplanar with the first portion 208.

The first transverse wall 202 carries, on its side facing away from the second transverse wall 204, a strip-like anchoring protrusion 214 arranged symmetrically about the central plane of the basic body of the spacer profile 200.

A further spacer profile 230 according to the invention is shown in FIG. 3F. The spacer profile 230 has a first transverse wall 232 and oriented parallel thereto and spaced therefrom, a second transverse wall 234. The two transverse walls 232, 234 are connected to and held spaced from one another by means of a single side wall element 236.

The first transverse wall 232 has, on its side facing away from the second transverse wall 234, a centrally arranged strip-like anchoring protrusion 238.

The side wall element 236 has an X-shaped configuration with a portion 244 extending directly and straight from a first edge region of the first transverse wall 232 to the first edge region 242 of the second transverse wall. The first edge regions 240, 242 of the first and second transverse wall lie on opposite sides of the rectangular-shaped basic body of the spacer 230. In its central region, the portion 244 has a protrusion 246 extending in the direction of a second edge region 250 of the first transverse wall 232 and a protrusion 248 extending in the direction of a second edge region 252 of the second transverse wall 234. When a force acts in a direction from the second transverse wall 234 toward the first transverse wall 232, even given a slight deformation of the spacer 230, the protrusions 246, 248 are supported against the first transverse wall 232 and/or the second transverse wall 234.

On its side facing away from the first transverse wall 232, the second transverse wall 234 carries, on its first and second edge regions 242, 252, protrusions 254, 255 which again can serve for fixing a press-on strip (not shown).

In FIG. 3G, a spacer profile 260 according to the invention is shown which comprises a first transverse wall 262, a second transverse wall 264 and a single side wall element 266 connecting these two parallel oriented transverse walls and holding them at a pre-set spacing.

Provided on the first transverse wall on its side facing away from the second transverse wall 264 is a strip-like anchoring protrusion 268 arranged centrally to the basic body of the spacer 260.

The side wall element 266 has a meandering form with five portions 270, 272, 274, 276 and 278 of which the first portion 270 is attached to a first edge region 280 of the first transverse wall and extends vertically therefrom in the direction toward the second transverse wall 264.

Attached to the first portion 270, extending substantially in the transverse direction of the basic body of the spacer 260 is the V-form second portion 272, substantially parallel to which, the fourth also V-form portion 276, is held spaced by means of the third portion 274. The fourth portion 276, finally, is connected by means of the fifth portion 278 which is oriented coplanar with the first portion 270 and parallel to the third portion 274, to a first edge region 282 of the second transverse wall 264. The first edge region 280 of the first transverse wall 262 is arranged on the same side of the basic body of the spacer 260 as the first edge region of the second transverse wall 264.

On the side facing away from the first transverse wall 262, the second transverse wall 264 carries, on its two opposing edge regions 282, 283, two protrusions 284, 285 which again can serve for receiving a press-on strip (not shown).

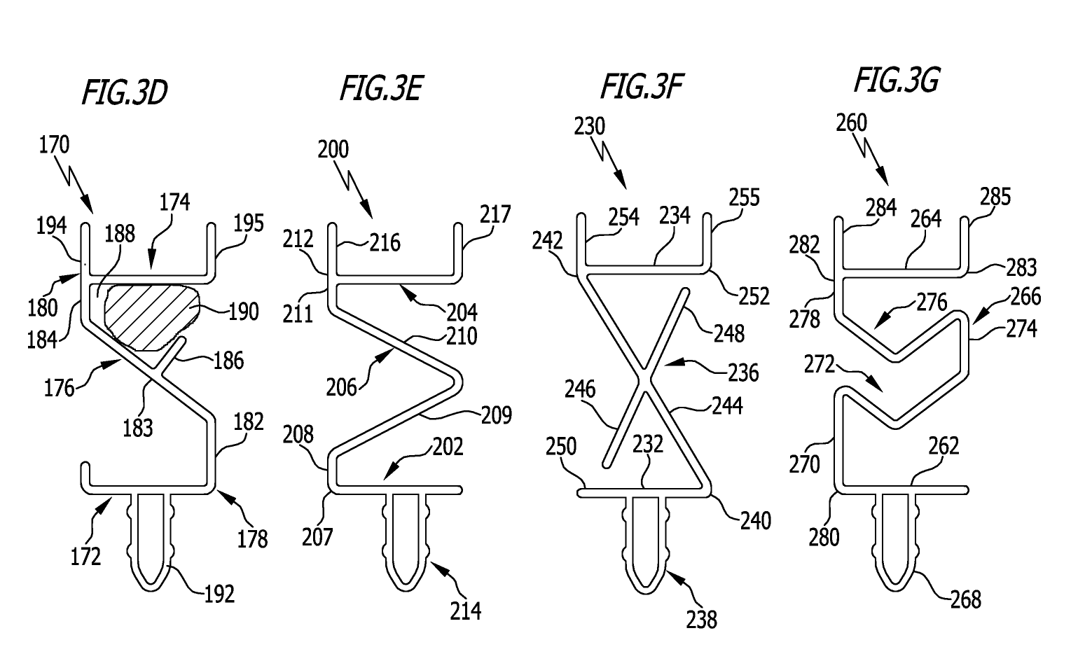

FIGS. 4A to 4D show four different variants of a spacer profile according to the invention the meandering geometry of which is suitable, in particular, for spacer profiles which have a relatively large structural height.

FIG. 4A shows a spacer profile 300 with a first transverse wall 302, and a second transverse wall 304 arranged parallel thereto. The first transverse wall 302 is connected to, and held at a pre-set spacing from, the second transverse wall 304 by means of a side wall element 306.

The side wall element 306 comprises five portions 308, 309, 310, 311, 312 which are arranged alternatingly, respectively at right angles to one another.

Herein, the three portions 308, 310, 312 are each oriented perpendicularly to the first and second transverse walls 302, 304 and parallel to one another and alternatingly arranged on opposite sides of the rectangular-shaped basic body of the spacer profile 300.

The portions 309 and 311 of the side wall element 306 arranged between the portions 308 and 310 and between 310 and 312 are arranged parallel to the transverse walls 302 and 304.

The first transverse wall 302 itself is subdivided into two strip-like portions 302a, 302b which extend at a pre-set spacing from one another in the longitudinal direction of the profile 300. The first transverse wall 302 has, on its side opposite to the second transverse wall 304, a strip-like anchoring protrusion 314 which is constructed with two wall portions 316, 317 which are connected to one another via a transverse web 318. The transverse web 318 herein bridges the gap between the two strip-like portions 302a and 302b of the first transverse wall 302. The position of the transverse web 318 lies just above half the height of the anchoring protrusion 314.

At its free end, the anchoring protrusion 314 remains open, whereby the end regions of the wall portions 316, 317 are slightly inclined toward one another and so produce a narrowing in the cross-section of the anchoring protrusion 314 at its free end. Also adjacent to the free end of the anchoring protrusion 314, the wall portions 316, 317 carry, at their oppositely positioned outer sides, ribs 320, 321 which serve to latch the spacer profile in a mounted position.

The spacer profile 300 of FIG. 4A further has at the first transverse wall 302 a support element 324 arranged parallel to the first portion 308 of the side wall element 306. The portions 309 and 311 of the side wall element 306 comprise further support elements 326, 328 arranged parallel to the support element 324. The support elements are dimensioned in their height so that a contact of the respective free end of the support element with the portion 309 or 311 lying thereabove of the side wall element 306 or in the case of the support element 328, a contact with the second transverse wall 304 in the unloaded state, and also following mounting of the profile 300, is prevented.

During mounting, however, due to the elastic deformability of the spacer profile 300, a contact between the second transverse wall 304 and the support element 328 or between the second portion 311 and the support element 326 and/or between the support element 324 and the portion 309 of the side wall element 306 can certainly occur, so that on insertion into the intended mounting site, even with a relatively large force application, no excessive deformation of the spacer profile 300 can occur.

In order to achieve a better seating of the support elements 324, 326, 328 on the respective transversely oriented portions 309, 311 or on the second transverse wall 304, the support elements 324, 326, 328 are angled at their free ends directed into the interior of the profile.

Furthermore, the spacer profile 300 comprises, on the second transverse wall, protrusions 330, 332 extending away from the first transverse wall 302 which form an upwardly open hollow space. On their upper free ends, the protrusions 330, 332 are provided with inwardly facing ribs 334, 335 which enable a latching connection with a cover element (not shown) which, following final mounting of the spacer profile, can be clipped onto a facade externally, or enable the connection with a press-on strip (not shown) which assumes the force transfer from a screw to a substructure and to glass or facade elements. Alternatively, a latching connection can be realised with a so-called press-on strip (not shown), by means of which, screw forces can be transmitted to a substructure and the adjacently arranged glass or facade elements.

The spacer profile 300 of FIG. 4A has the further special feature that the second transverse wall 304 and the portions 309 and 311 of the side wall element 306 which are arranged parallel to the second transverse wall 304 comprise, in the region of the central plane of the basic body of the spacer profile 300, a depression 338, 339, 340, in the form of a groove, which serve for the guidance of screws parallel to the central plane of the basic body (shown schematically in FIG. 4A) during mounting and fixing of the spacer profile on the facade.

The spacer profile 300 is further equipped on both sides of the basic body with sealing elements which are shown here, merely for the sake of simplicity, in different configurations. Typically, in one spacer profile, the sealing elements at all levels in which they are needed are of the same type.

The sealing elements can be produced separately and connected to the spacer profile or configured integrally therewith.

In the plane of the second transverse wall 304, sealing elements in the form of sealing strands 342, 343, for example made of a foamed material, are provided which lie on adjacent facades or glass elements of a glass roof or facade construction.

At the level of the portion 311, arranged on both sides are sealing lips 344, 345 which have a slightly curved form, wherein the free ends of the sealing lips 344, 345 are oriented in the direction toward the second transverse wall 304 lying thereabove.

An alternative embodiment of the sealing lips is in the form of the sealing lips 346, 347 in the plane of the portion 309, which extend substantially straight away from the basic body of the profile 300.

In place of the sealing elements formed integrally with the spacer profile 300, a further alternative embodiment has sealing elements in the form of lateral protrusions 348, 349 which are shown here at the height of the first transverse wall 302. With such protrusions also, the sealing effect can be significantly improved.

FIG. 4B shows a further variant of a thermally insulating spacer profile 370. The spacer profile 370 has a first transverse wall 372 and a second transverse wall 374 which are held at a spacing by a side wall element 376.

The side wall element 376 comprises seven portions 378, 379, 380, 381, 382, 383 and 384 of which four portions 378, 380, 382, 384 are arranged parallel to one another on alternating outer sides of the basic body of the spacer profile 370, oriented in the direction from the first transverse wall 372 to the second transverse wall 374.

The portions 379, 381, 383 arranged therebetween are oriented parallel to the second transverse wall 374 and have an angled configuration, wherein the bend sites of the angled portions come to lie substantially on the central plane of the basic body.

The first transverse wall 372 is again subdivided into two strip-like elements 372a, 372b which, as described above in relation to FIG. 4A, carry a strip-like anchoring protrusion 386 which consists of two wall elements 388, 389 and a transverse web 390. Regarding the further details of the configuration of the spacer profile 370 in relation to the first transverse wall and the anchoring protrusion 386 formed thereon, reference is made to the description relating to FIG. 4A.

The first transverse wall 372 has, bordering on its strip-like portion 372b, an upwardly directed protrusion 392, the function of which lies in receiving a foil, a flat foam material or a sealing lip (all not shown here).

On its side facing away from the first transverse wall 372, the second transverse wall 374 carries two protrusions 394, 396 which have at their free ends latching elements 398, 399, the function of which is similar to that in FIG. 4A, so that reference is made to the description thereto.

The spacer profile 370 of FIG. 4B also has infrared-reflecting coatings on the portions 379, 381 and 383 and on the second transverse wall 374, in each case on the side facing the first transverse wall 372.

The infrared-reflecting coatings 400, 401, 402 and 403 significantly improve the thermal insulating properties of the spacer profile 370 in that infrared radiation which is incident from the direction of the first transverse wall 372 onto the heat-reflecting coatings 400, 401, 402, 403 is respectively reflected back in the direction of the first transverse wall 372. Alternatively, a reduction in the emission level c of the surface can be achieved by means of the coatings, so that the thermal radiation is reduced by the coatings 400, 401, 402, 403.

Alternatively or additionally to the reflective coatings 400, 401, 402, 403, reflective coatings can be provided on the opposite sides of the side wall portions 379, 381 and 383, as illustrated by the reflective coatings 404, 405, 406 shown dashed.

FIG. 4C shows a thermally insulating spacer profile 420 with a first transverse wall 422, and a second transverse wall 424 arranged parallel thereto. The two transverse walls 422, 424 are held at a spacing from one another by means of a side wall element 426 which comprises five portions 428, 429, 430, 431, 432, of which the portions 428, 430 and 432 are each arranged parallel to one another and perpendicular to the first and second transverse walls 422, 424. Due to the alternating arrangement at outer sides of the rectangular basic body, an alternating arrangement corresponding to the meandering form of the spacer 420 results.

The portions 429 and 431 arranged therebetween lie parallel to the transverse walls 422, 424 and connect the respective portions 428, 430 or 430, 432 to one another.

Provided in the portions 429 and 431 arranged parallel to the transverse walls 422, 424 of the side wall element 426 are screw guides in the form of protrusions 434, 436. The second transverse wall 424 is also provided with a screw guide in the form of protrusions 438.

In the case of the first transverse wall 422, a screw guide results from the bifurcation of this transverse wall into strip-like portions 422a, 422b, which extend at a spacing from one another in the longitudinal direction.

Applied onto the opposite sides of the rectangular-shaped basic body of the spacer profile 420 from the first transverse wall 422 to the free ends of the protrusions 440, 442 extending from the second transverse wall 424 are foils 444, 446 over the whole area, which preferably extend from their lower end adjoining the first transverse wall 422, preferably also over a part of the first transverse wall and its side carrying the strip-like anchoring protrusion 448.

The foils 444, 446 contribute at best slightly to improving the mechanical stability of the spacer profile 420, but they substantially improve the thermal insulation properties of the spacer profile 420, since the otherwise laterally open volumes between the first transverse wall 422, the portion 428 and the portion 429 of the side wall element 426 on one side, the open cross-section formed by the portions 429, 430 and 431 of the side wall element 426 and the open volumes formed by the portions 431 and 432 of the side wall element 426 and the second transverse wall 424, are closed, so that convection currents and the heat transmission associated therewith are minimised or suppressed. The foil 444 does not need, for the stated purpose of closing the open volume formed by the side wall portions 429, 430 and 431, to extend over the whole height of the basic body, but a significantly smaller width than with the foil 446 is sufficient herefor.

FIG. 4D shows a spacer profile 460 according to the present invention, wherein a first transverse wall 462 is held parallel to and at a spacing from a second transverse wall 464 by means of a side wall element 466. The side wall element 466 again comprises five portions 468, 469, 470, 471, 472 of which the portions 469, 471 are arranged parallel to the first transverse wall 462 and the second transverse wall 464 and of which the portions 468, 470 and 472 which create the connection between the first transverse wall 462 and the second portion 469 and between the two portions 469, 471 and between the portion 471 and the second transverse wall 464, are arranged perpendicularly thereto.

The first transverse wall 462 is subdivided into two strip-like portions 462a, 462b which are held spaced from one another extending in the longitudinal direction of the spacer profile 460. The first transverse wall 462 carries on its side facing away from the second transverse wall 464 a strip-like anchoring protrusion 474 which is constructed as previously described in relation to FIGS. 4A to 4C so that detailed description is superfluous here.

The portions 469, 471 of the side wall element 466, like the second transverse wall 464, have depressions 476, 478, 480 in the form of groves extending along the central plane of the basic body of the spacer profile 460, which serve for the guidance of screws during the screw-fixing of the spacer profile at its mounting position.

At the side facing away from the first transverse wall 462, the second transverse wall 464 has two protrusions 482, 484 which comprise at their free ends latching noses 486, 487 which are arranged facing one another and so enable latching with a so-called press-on strip (not shown).

Arranged on both sides of the rectangular basic body of the spacer profile 460 are foamed surface materials 490, 492 which extend over a large part of the height of the spacer profile 460 or of its basic body and therein each cover the laterally open volume portions of the spacer profile 460.

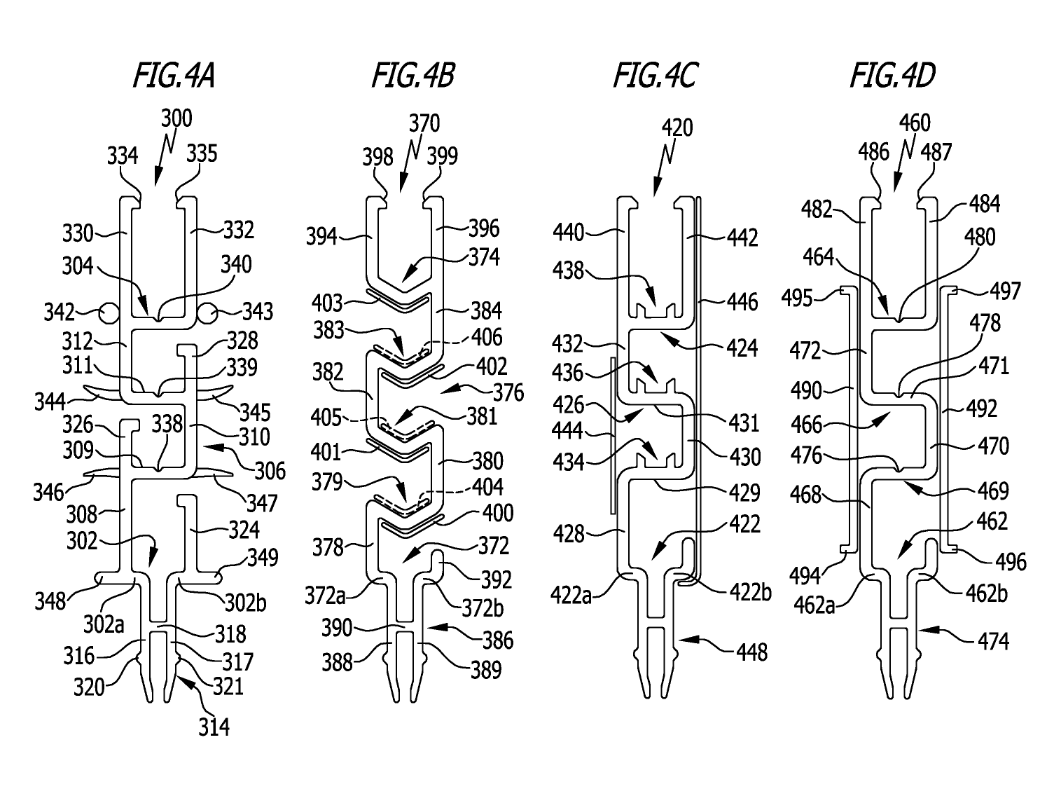

The foamed material thus serves firstly to suppress convection and thus to improve the thermal insulation and secondly this material also provides lateral sealing of the spacer profile 460 relative to adjacently arranged glass or facade panels. For further improvement of this function, the surface materials 490, 492 preferably have at their free ends, possibly also distributed over their height, strip-like protrusions 494, 495 and 496, 497. If the foamed surface materials 490 and 492 serve essentially only for lateral closing of the open volumes, the height of the material 490 could again be restricted, similarly to the foil 444 of FIG. 4C, to the region of the side wall element 466 which is formed by the portions 469, 470 and 471. In the variant shown in FIG. 4D, however, the foamed materials contribute to a reduction of the lateral spacing to the facade elements and are therefore used on both sides of the basic body with the same height. A further variant of a spacer profile according to the invention is shown in FIG. 5 wherein the spacer profile 500 is constructed with a first transverse wall 502 and a second transverse wall 504, wherein the transverse walls 502, 504 are held at a spacing parallel to one another by means of a side wall element 506.

The side wall element 506 comprises three portions 508, 509, 510, of which the portions 508 and 510 are arranged perpendicularly to the transverse walls 502, 504, whereas the portion 509 of the side wall element 506 is oriented parallel to the transverse walls 502, 504.

The transverse walls 502, 504 and the portion 509 are provided in the region of the central plane of the cuboid-shaped basic body of the spacer profile 500 with a depression in the form of a groove which also extends along the central plane of the cuboid-shaped basic body and serves for guiding the screw tips and thus facilitates the mounting of the spacer profiles 500.

Provided between the first transverse wall 502 and the portion 509 of the side wall element 506 and between the portion 509 and the second transverse wall 504, respectively, are laterally open volumes 512, 514 which are filled flush with a foam mass. Due to the filling of the partial volumes 512, 514, further measures for suppressing convection are unnecessary and these foam-filled volumes improve not only the mechanical stability of the spacer profile 500, but also the thermal insulation that can be achieved with this spacer profile.

The first transverse wall 502 carries, on its side facing away from the second transverse wall 504, a strip-like anchoring protrusion 516 which is configured similarly to the anchoring protrusions previously described in relation to FIGS. 4A to 4D. What is different in this embodiment is only that the first transverse wall 502 is not bifurcated, but is formed as an integral element continuously from one side to the other of the basic body of the spacer profile 500.

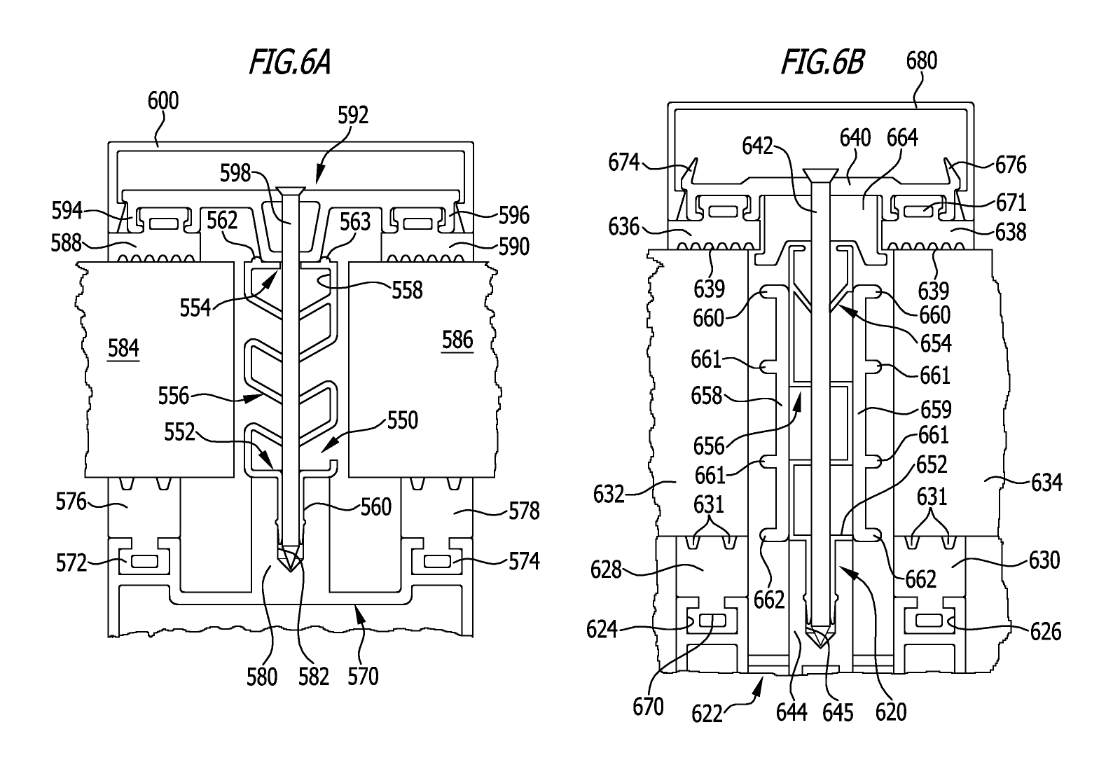

FIGS. 6A and B show two further embodiments of the spacer profile according to the invention in an installed situation of a facade cladding.

FIG. 6A shows a spacer profile 550 with a first transverse wall 552 divided into two longitudinal strips, and a second transverse wall 554 arranged parallel thereto. The two transverse walls 552, 554 are connected to, and held at a spacing from, one another by means of a side wall element 556, similarly as described multiple times in the spacer profiles illustrated and described in detail above.

The side wall element 556 is constructed to be meandering with a plurality of portions arranged parallel to one another which are oriented perpendicularly to the first and second transverse wall 552 and 554, and V-shaped portions each arranged between these portions, each extending from one side of the rectangular-shaped basic body of the spacer profile 550 to the other side of this basic body.

Adjacent to the second transverse wall 554, the V-shaped configured portion of the side wall element 556 there forms a hollow chamber 558 with the second transverse wall 554 and a portion of the side wall element.

The first transverse wall 552 comprises, centrally aligned on its side facing away from the second transverse wall 554, a strip-like anchoring protrusion 560, whereas the second transverse wall 554 comprises on its side facing away from the first transverse wall 552, two parallel-arranged guide ribs 562, 563, the function of which will be described in detail below.

FIG. 6A shows a portion of a facade cladding and herein the spacer profile 550 in the resulting installation situation, wherein on the building side, a substructure with a so-called post-and-beam profile 570 is provided which has, on its side facing away from the building side, receiving chambers 572 and 574 into which sealing profiles 576, 578 made of an elastomer material can be inserted.

Centrally, the post-and-beam profile 570 carries a block-shaped mounting body 580 which includes a receiving groove 582 provided centrally into which the anchoring protrusion 560 of the spacer profile 550 can be introduced in clamping seating.

On both sides of the spacer profile 550, lying on the sealing profiles 576, 578 are insulating glass panes 584, 586 which again are in contact on their surface remote from the building with sealing profiles 588, 590. These sealing profiles 588, 590 are also made of an elastomer material.

These sealing profiles 588, 590 are again held by a so-called press-on strip 592 in its receptacles 594, 596.

The press-on strip 562 is itself guided centred to the spacer profile 550 with a hollow chamber projecting in the direction of the building between the ribs 562, 563 of the spacer profile 550, and is screwed through with screws 598 along the midline of the basic body of the spacer profile 550, as far as into the anchoring protrusion 560.

By means of the screwing in of the screw 598 through the press-on strip 592 and through the spacer profile 550 into the receiving groove 582, the portions of the anchoring protrusion 560 are pressed, due to the given dimensions, against the walls of the receiving groove 582 of the anchoring block 580 and so the spacer profile 550 is anchored with its anchoring protrusion 560 in the manner of a wall plug in the post-and-beam profile 570.

At the same time, the insulating glass panes 584, 586 are thereby held in their position by means of the press-on strip 592.

After completion of the mounting, finally a cover profile 600 is clipped onto the press-on strip 592. For this purpose, the U-shaped cover profile 600 is provided on the respective free ends with latching noses, which can engage in recesses on the press-on strip 592.

A comparable installation situation is also shown in FIG. 6B, wherein a spacer profile 620 is screwed onto a post-and-beam profile 622 which is fastened to a facade (not shown) of a building.

The post-and-beam profile 622 also has receiving chambers 624, 626 into which sealing profiles 628, 630 can be inserted which are typically made of an elastomer material. Centrally between the receiving chambers 624, 625, the post-and-beam profile 622 comprises a block-shaped receiving body 644 with a longitudinal groove 645 for receiving a strip-like anchoring protrusion of the spacer profile 620.

Against the sealing strips 628, 630 there come to lie insulating glass panes or other facade panels 632, 634, which are acted upon on their opposite side by sealing strips 636, 638 which are fixed onto a press-on strip 640 or are fixed in receiving chambers thereof. The press-on strip 640 is fixed by means of screws 642, which are screwed through the central plane of the spacer profile 620, to the post-and-beam profile 622, wherein the tip of the screw penetrates into the groove 645 of the block-shaped body 644 of the post-and-beam profile 622 and thereby the spacer profile 620 is fixed to the post-and-beam profile 622 by means of the anchoring process.

The spacer profile 620 has a first transverse wall 652 and a second transverse wall 654, wherein the first transverse wall 652 is subdivided into two strips which are connected to one another via webs arranged regularly along the length of the spacer profile 620.

Whilst the transverse wall 652 is formed flat, the transverse wall 654 is V-shaped and has at its deepest point the regularly provided openings for the passage of the screws 642.

The first transverse wall 652 is connected by means of a side wall element 656 to the second transverse wall 654 and is held at a spacing, wherein here again a meandering form of the side wall element 656 has been selected.

The structural height of the spacer profile 620 is greater than in the case of the spacer profile 550 of FIG. 6A, since the glass panels 632, 634 have a greater thickness, for example, because herein glazing is provided with more layers than the glazing as in FIG. 6A.

Applied onto the outer side of the profile body of the spacer profile 620 are flat foam structures 658, 659 which firstly laterally close the hollow spaces in the meandering profile of the spacer profile 620 and secondly also comprise laterally outwardly projecting protrusions 660, 661, 662 which preferably extend so far in the direction of the laterally placed panels 632, 634 that the spacing amounts to 2 mm or less. Thus a possible convection in the region between the panels 632, 634 and the spacer profile 620 is effectively prevented or reduced to a no longer relevant amount.

Placed between the spacer profile 620 and the press-on strip 640 is a foam strip 664 which there firstly fills the space between the sealing strips 636, 638 and furthermore insulates the press-on strip 640 thermally against the space lying thereunder in which the spacer profile 620 is arranged.

Both the sealing strips 628, 630 and also the sealing strips 636, 638 have on their sides facing toward the panels 632 and 634, depressions 631 and 639 in the form of grooves which serve for better force distribution on pressing the sealing strips 628, 630, 636, 638 onto the surfaces of the panels 632, 634. In particular, therewith, an inclusion of gas bubbles between the sealing strips 628, 630, 636, 638 and the respective panel 632, 634 on mounting can be counteracted.

Provided in the sealing strips 628, 630 and the sealing strips 636, 638 in their parts received by the receiving chambers of the post-and-beam profiles 622 or the press-on strip 640 are hollow chambers 670, 671 which enable a simpler deformation on insertion of the sealing strips into the corresponding holders of the post-and-beam profiles on one side and the press-on strip 640 on the other side.

The press-on strip 640 further has on its side facing away from the building guide protrusions 674, 676 which, on placement of a cover strip 680, guide its free limb so that it can be easily latched in place with its latching elements onto the press-on strip 640.

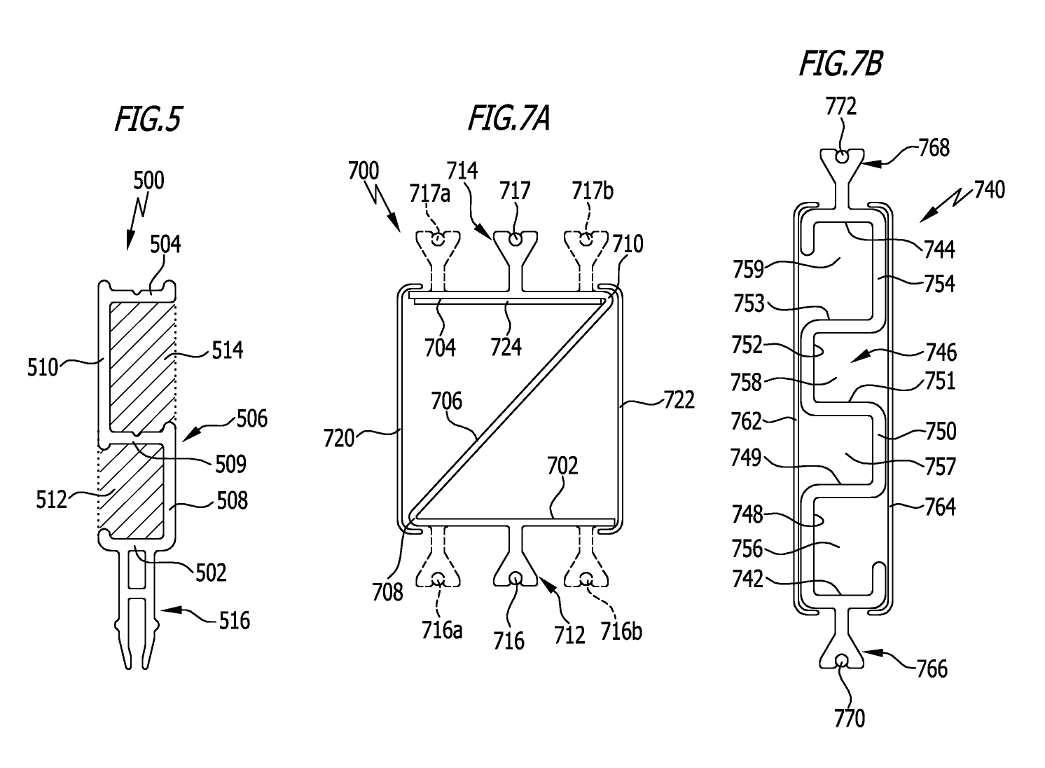

Finally, in FIGS. 7A and 7B it is shown that the spacer profiles according to the invention can also be configured for metal composite profiles, wherein the connection between the spacer profile and the metal profiles is preferably created by means of a so-called rolled-in connection.

In detail, FIG. 7A shows a spacer profile 700 in a Z-shaped implementation, wherein a first transverse wall 702 is connected to and held at a spacing from a second transverse wall 704 by means of a single side wall element 706.

The diagonally extending side wall element 706 in the basic body of the spacer profile 700 is formed on at a first edge region 708 of the first transverse wall 702 and at the end opposite thereto is also formed onto a first edge region 710 of the second transverse wall 704.

Both transverse walls have centrally arranged on their outwardly lying surfaces configured as roll-in protrusions 712, 714, strip-like anchoring protrusions the free end of which is formed trapezoid in cross-section and has a receiving groove for a so-called sealing wire 716, 717.

Onto the two hollow chambers of triangular cross-section resulting from the Z-shape of the spacer profile 700, which are laterally open, a foil 720, 722 or a foamed surface material can be applied in order to improve the thermal values, wherein the upper and lower ends of the foil or a suitable surface material preferably end at the respectively outwardly lying sides of the first and second transverse wall 702, 704.

Additionally or alternatively, the transverse walls 704, 702 and also the side wall element 706 can also be provided with a reflective foil in order, by this means, further to improve the thermally insulating properties of the spacer profile 700.

If necessary, the laterally open hollow spaces can also be filled with a foam material (not shown).

With profile widths as with the spacer profile 700, it can also be provided that at the first and second transverse wall, two parallel roll-in protrusions are provided respectively as anchoring protrusions in place of the anchoring protrusions 716, 717, wherein these are then preferably arranged symmetrically with spacing from a central plane of the basic body of the spacer profile (see dashed representation of the strip-like anchoring protrusions in the form of roll-in protrusions 716a, 716b, 717a, 717b).

The inwardly facing surface of the transverse walls 702 and/or 704 can be provided with an IR-reflecting coating 724 or a coating with low emission levels (in the present example, only the transverse wall 704 is equipped with such a coating 724).

In FIG. 7B, a narrower spacer profile 740 is shown which comprises a first transverse wall 742, a second transverse wall 744 and a single side wall element 746 connecting the transverse walls 742, 744 to one another and holding them at a pre-set spacing.

The side wall element 746 is structured to be meandering with seven portions 748, 749, 750, 751, 752, 753 and 754, of which four of the portions 748, 750, 752 and 754 are oriented perpendicularly to the transverse walls 742, 744 and three of the portions 749, 751 and 753 are parallel to the transverse walls 742, 744.

The open hollow chambers 756, 757, 758 and 759 thereby formed can be filled with a foam mass (not shown) or closed with a foil 762, 764 to suppress convection effects. Furthermore, the portions of the side wall element 746 oriented parallel to the transverse walls or the inwardly facing surfaces of the first and/or second transverse wall can be provided with an IR-reflecting coating or a coating with a low emission level in order further to improve the thermal insulation of the spacer profile 740.

Arranged centrally to the basic body of the spacer profile 740 on the outwardly lying surfaces of the transverse walls are anchoring protrusions in the form of strip-like anchoring protrusions in the form of roll-in protrusions 766, 768, with which the spacer profile 740 can be assembled with metal profiles (not shown) to a composite profile. On their outwardly lying surfaces, the roll-in protrusions 766, 768 also preferably have grooves in which so-called sealing wires 770, 772 can be received.

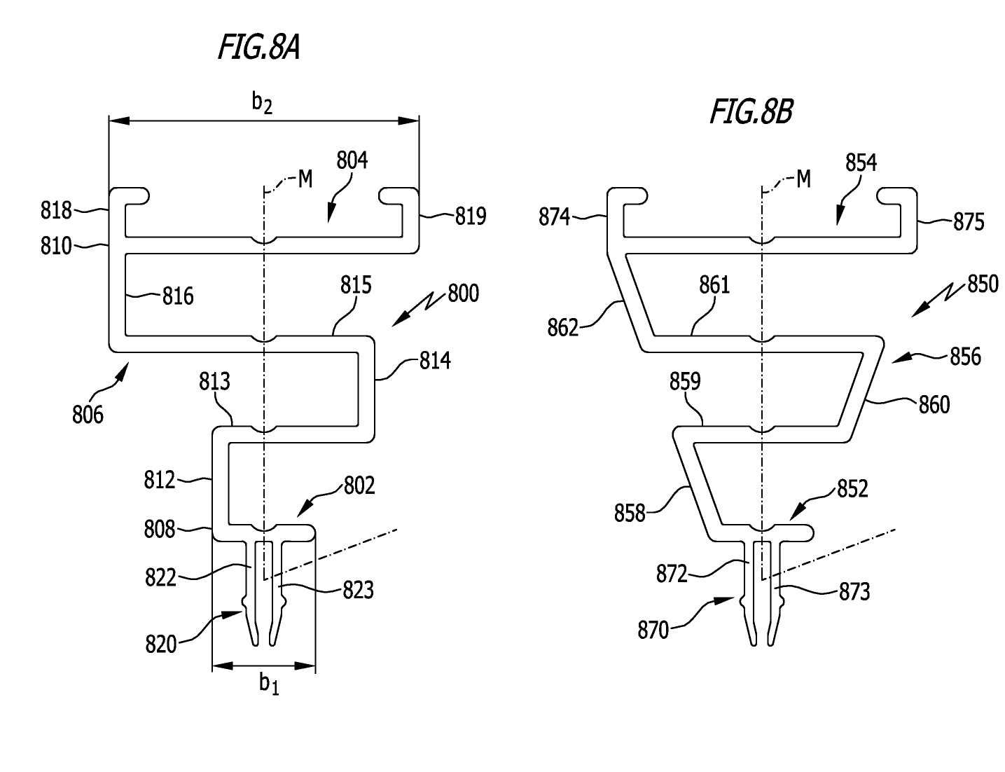

FIGS. 8A and 8B show two examples of a thermally insulating spacer profile with a substantially trapezoid-shaped outer contour of the basic body in cross-section perpendicular to the longitudinal direction.

The thermally insulating spacer profile 800 of FIG. 8A has a first transverse wall 802 and a second transverse wall 804 arranged parallel thereto, wherein the width b1 of the transverse wall 802 is approximately one third of the width b2 of the second transverse wall 804.

The two transverse walls 802, 804 are held at a spacing from one another by means of a supporting side wall element 806 which extends in a plurality of portions in a meandering form from a first edge region 808 of the first transverse wall 802 to a first edge region 810 of the second transverse wall 804. The different portions of the side wall element 806 are either arranged substantially perpendicular to the transverse walls 802, 804 (portions 812, 814, 816) or parallel thereto (portions 813, 815), wherein the width of the side wall portions 813, 815 oriented parallel to the transverse walls increases in steps in the direction from the first transverse wall 802 to the second transverse wall 804.

The side wall portions 812, 814, 816 which are oriented substantially perpendicular to the transverse walls 802, 804 have a substantially identical extent in the direction from the first transverse wall 802 to the second transverse wall 804, wherein here also, depending on the requirements placed on the spacer profile, variations are possible.

The side wall portions 813, 815 extending parallel to the transverse walls 802, 804 have a recess in the region of the central plane M of the spacer profile, just like the first and second transverse wall 802, 804, which serves for centring the screws provided for fastening the spacer profile 800.

On its side facing away from the first transverse wall 802, the second transverse wall 804 carries two latching protrusions 818, 819 by means of which a press-on strip (not shown) can be latchingly fastened to the spacer profile.

The first transverse wall 802 has on its side facing away from the second transverse wall 804 a strip-like anchoring protrusion 820 which is arranged symmetrically to the central plane M and which has two wall portions 822, 823 arranged substantially parallel, which can be connected to one another, if required, by means of a transverse web (not shown).

FIG. 8B shows a spacer profile 850 according to the present invention, wherein a first transverse wall 852 is held at a mutual spacing from a second transverse wall 854 by means of a single side wall element 856.

The side wall element 856 has three portions 858, 860 and 862 arranged inclined to a central plane M, connected to one another by means of portions 859, 861 arranged substantially parallel to the transverse walls 852, 854. In their regions crossing the central plane M, the first transverse wall 852 and the second transverse wall 854 and the side wall portions 859, 861 each have a recess which serves for the guidance of screws on mounting the spacer profile 850.

The first transverse wall 852 has on its side facing away from the second transverse wall 850 a strip-like anchoring protrusion 870 which is formed by two wall portions 872, 873 arranged parallel and centred to the central plane M, which can be connected to one another, if required, by means of a transverse web (not shown).

On its side facing away from the first transverse wall 852, the second transverse wall 854 comprises two anchoring protrusions 874, 875 by means of which a press-on strip (not shown) can be connected with a latching connection to the spacer profile, once this has been mounted.

Due to the wedge-shape of the embodiments of FIGS. 8A and 8B of the spacer profiles 800 and 850 according to the invention, these are suitable, in particular, for installation between two panels which are not arranged in a plane aligned with one another, but at an angle to one another so that the V-shaped gap thereby arising can be substantially filled by the spacer profile according to the invention. These two embodiments are intended to show that account can be taken of specific circumstances of the facade configuration by means of a corresponding form of the basic body of the spacer profile according to the invention, in particular, its configuration in trapezoid form.

Herein, it can also certainly occur that the first transverse wall has a greater width than the second transverse wall and/or that the two transverse walls are not parallel, but are arranged at a certain angle to one another.

It is also conceivable that the transverse walls of the spacer profile are not arranged perpendicularly to the central plane M, but at an angle other than 90°, also to take account of corresponding conditions in the facade configuration.

In the different embodiments of the present invention, the spacer profiles have been described in many details, wherein the specific profile cross-sections addressed therein, in particular the configurations relating to the screw guides, the lateral seals, the reflective surface coatings and the foam-filled hollow volumes as well as the lateral coating with foils or foamed surface materials can be transferred to the respective other embodiments that are disclosed.

In the same way, a person skilled in the art would choose the materials, wall thicknesses, profile geometries, placement and configuration of the sealing and insulating elements according to the respective intended purpose of the spacer profiles according to the invention.

Similarly, the different embodiments of the anchoring protrusions are clearly transferrable by the skilled person to the other embodiments without difficulty.

1. A thermally insulating spacer profile made of a plastics material, comprising:
a basic body extending in a longitudinal direction of the spacer profile with an outer contour which is substantially rectangular or trapezoid-shaped in a cross-section perpendicular to the longitudinal direction;
wherein the basic body comprises a first transverse wall and a second transverse wall which are connected to one another by a single side wall element and are held at a pre-set spacing h;
wherein the side wall element ends with a first end at a first edge region of the first transverse wall and with a second end at a first edge region of the second transverse wall;
wherein the side wall element forms a path for thermal conduction from the first transverse wall to the second transverse wall, said path having a length approximately 1.1 or more times the spacing h;
and comprising a strip-like anchoring protrusion which is held on the first transverse wall and which extends from the basic body in a direction opposite to the second transverse wall.

2. The spacer profile according to claim 1, wherein the first transverse wall and the second transverse wall are oriented substantially parallel to one another.

3. The spacer profile according to claim 1, wherein the side wall element comprises two or more portions which are arranged at different angles relative to the first transverse wall and the second transverse wall.

4. The spacer profile according to claim 1, wherein the side wall element extends as far as a central plane of the basic body or crosses the central plane one or more times, wherein the central plane extends in the longitudinal direction of the spacer profile and parallel to a spacing direction of the first and second transverse wall.

5. The spacer profile according to claim 1, wherein the side wall element comprises at least one portion which is arranged substantially perpendicularly to the first or second transverse wall.

6. The spacer profile according to claim 1, wherein the side wall element comprises at least one portion which is arranged substantially parallel to the first and/or the second transverse wall.

7. (canceled)

8. The spacer profile according to claim 1, such that the first edge region of the first transverse wall and the first edge region of the second transverse wall at which the side wall element ends are arranged at opposite sides of the basic body.

9. The spacer profile according to claim 1, such that the first edge region of the first transverse wall and the first edge region of the second transverse wall at which the side wall element ends are arranged at the same side of the basic body.

10. The spacer profile according to claim 1, wherein the side wall element forms a path for the thermal conduction from the first transverse wall to the second transverse wall, the length of said path corresponding to approximately 1.2 or more times the spacing h of the transverse walls from one another.

11. (canceled)

12. The spacer profile according to claim 1, wherein the spacer profile comprises, in cross-section, on at least one of the first and second transverse walls and/or on at least one of the portions of the side wall element, a profiling which is configured as a screw guide.

13-14. (canceled)

15. The spacer profile according to claim 1, wherein the second transverse wall comprises a protrusion on a side of the second transverse wall facing away from the first transverse wall on the first edge region and on the second edge region opposite the first edge region.

16. The spacer profile according to claim 1, wherein one or more of the portions of the side wall element and/or at least one of the transverse walls on a surface facing toward the anchoring protrusion and/or away from the anchoring protrusion is equipped with a layer reflecting infrared radiation.

17. The spacer profile according to claim 1, wherein at least a partial volume of the basic body is filled with a foam material.

18. The spacer profile according to claim 1, wherein the spacer profile is equipped on its regions of the outer contour of the basic body extending between the transverse walls with a foil extending in the direction from the first transverse wall to the second transverse wall or with a foamed surface material.

19. The spacer profile according to claim 1, wherein at least one of the transverse walls and/or one of the portions of the side wall element is equipped or configured on a region adjoining the outer contour of the basic body with a sealing element.

20. The spacer profile according to claim 1, wherein at one or more of the portions of the side wall element and/or at the first and/or second transverse wall, support elements are provided which, on loading of the spacer profile in the direction from the second transverse wall to the first transverse wall, are bringable into abutment with a further portion of the side wall element and/or with the first and/or second transverse wall

21. The spacer profile according to claim 1, wherein anchoring protrusions which have a trapezoid form in cross-section are formed both on the first and also on the second transverse wall.

22. The spacer profile according to claim 1, wherein the spacer profile comprises an anchoring protrusion only on the first transverse wall.

23-25. (canceled)

26. The spacer profile according to claim 1, wherein the plastics material of the spacer profile is selected from polyamides, polyesters, polyethers, polyolefins, polyaryletherketones, polyacetals, polycarbonates, polyacrylates, polystyrenes, polyphenylene ethers, polyurethanes, epoxy resins, polysulphones, vinylpolymers, polyphenylene sulphides, copolymers and/or blends of these plastics materials.

27. (canceled)

28. The spacer profile according to claim 1, wherein the plastics material is in a porous form, in particular, with a pore volume content of approximately 1% to approximately 20% by volume.
